(19) United States
(12) Patent Application Publication
(10) Pub. No.: US 2015/0144005 A1
(43) Pub. Date: May 28, 2015

(54) FOOD PRODUCT TOASTING MACHINE

(71) Applicant: Richard A. Becker, Chandler, AZ (US)

(72) Inventor: Richard A. Becker, Chandler, AZ (US)

(21) Appl. No.: 14/090,398

(22) Filed: Nov. 26, 2013

(51) Int. Cl. A23G 3/02

(52) U.S. Cl. CPC A23G 3/02
USPC 99/332; 99/426

(57) ABSTRACT

A toasting machine for toasting a food product includes a housing having a bottom and a top, and a heating source for toasting a food product. The heating source is mounted in the housing and extends upright in a direction from the bottom of the housing to the top of the housing, and completely encircles a toasting chamber in the housing for sourcing surrounding heat to the toasting chamber. An opening in the top of the housing communicates with the toasting chamber for admitting a food product into the toasting chamber for toasting. The heating source is a heat-insulative wall that has an inner face that completely encircles the toasting chamber, and resistance wire carried by the wall, which is uniformly distributed along the inner face of wall for sourcing surrounding heat to the toasting chamber.

### FIELD OF THE INVENTION

The present invention relates to kitchen appliances and, more particularly, to countertop toasters useful for toasting food products, and especially marshmallows.

### BACKGROUND OF THE INVENTION

A marshmallow is a molded, small, cylindrical confection. While it is widely believed that marshmallows were originally developed for medicinal purposes, marshmallows are enjoyed as a sweet treat eaten alone, or used as an ingredient in recipes.

Marshmallows are particularly appetizing when toasted. Toasting a marshmallow, such as over an open flame, partially melts the marshmallow and caramelizes the exterior. A toasted marshmallow can be eaten whole or incorporated into a recipe, such as a smore made by placing the toasted marshmallow on a piece of chocolate placed between two graham crackers.

A common way of toasting a marshmallow is over an open flame, such as over a campfire. However, an open flame or a campfire is not always readily available. As a result, skilled artisans have developed a variety of electric appliances specifically configured to toast marshmallows. Many such prior art appliances utilize rotating skewers to hold the marshmallow and rotate it with respect to a heating source. Others utilize rotating fixtures that rotate the marshmallow around a heating source while simultaneously rotating the marshmallow. Attempts at evenly toasting a marshmallow have, unfortunately, resulted in extremely complex and impracticable machinery with results that are not entirely satisfactory.

### SUMMARY OF THE INVENTION

According to the principle of the invention, a toasting machine for toasting a food product includes a housing having a bottom and a top, and a heating source for toasting a food product. The heating source is mounted in the housing and extends upright in a direction from the bottom of the housing to the top of the housing, and the heating source completely encircles a toasting chamber in the housing for sourcing surrounding heat to the toasting chamber. An opening in the top of the housing communicates with the toasting chamber for admitting a food product into the toasting chamber for toasting. The heating source includes a wall of heat-insulative material, and resistance wire. The wall extends upright and has an inner face that completely encircles the toasting chamber. The resistance wire is carried by the wall, and is uniformly distributed along the inner face of the wall for sourcing surrounding heat to the toasting chamber. In a particular embodiment, the resistance wire is arranged in spaced-apart parallel rows that extend upright along the inner face of the wall in concert with the wall. The wall is formed of a plurality of wall segments. Each wall segment is joined to an adjacent wall segment via a hinge, which is preferably a living hinge. The toasting machine further includes a timer for automatically timing the heating source operating to automatically apply surrounding heat to the toasting chamber for select time periods.

According to the principle of the invention, a toasting machine for toasting a food product includes a housing, having a bottom and a top, a floor of heat-resistant material in the housing, and a heating source in the housing for toasting a food product. The floor is near the bottom and opposes the top, and the heating source is in the housing between the floor and the opening, extends upright in a direction from the floor near the bottom of the housing to the top of the housing, completely encircles a toasting chamber in the housing for sourcing surrounding heat to the toasting chamber, and is coupled between the floor and the housing. An opening in the top of the housing communicates with the toasting chamber for admitting a food product into the toasting chamber for toasting. The heating source includes a wall of heat-insulative material, and resistance wire. The wall has a lower extremity, an upper extremity, and an inner face, the wall extends upright from the lower extremity connected to the floor to the upper extremity connected to the housing, and the inner face completely encircles the toasting chamber. The resistance wire is carried by the wall, and is uniformly distributed along the inner face of the wall for sourcing surrounding heat to the toasting chamber. In a particular embodiment, the resistance wire arranged in spaced-apart parallel rows that extend upright along the inner face of the wall in concert with the wall. The wall is formed of a plurality of wall segments. Each wall segment is joined to an adjacent wall segment via a hinge, which is preferably a living hinge. The toasting machine further includes a timer for automatically timing the heating source operating to automatically apply surrounding heat to the toasting chamber for select time periods. Guides are formed in the top of the housing, which are for receiving and guiding a food carrier into the toasting chamber through the opening.

According to the principle of the invention, a toasting machine for toasting a food product includes a housing, having a bottom and a top, a floor of heat-resistant material in the housing, and a heating source in the housing for toasting a food product. The floor is in the housing near the bottom and opposes the top. The heating source is in the housing between the floor and the opening, extends upright in a direction from the floor near the bottom of the housing to the top of the housing, encircles a toasting chamber in the housing for sourcing surrounding heat to the toasting chamber, and is coupled between the floor and the housing. An opening in the top of the housing communicates with the toasting chamber for admitting a food carrier into the toasting chamber in a toasting position for positioning a food product held by the food carrier in the toasting chamber. The toasting machine further includes a timer for automatically timing the heating source operating to automatically apply surrounding heat to the toasting chamber for select time periods, and a switch in the housing that is operatively coupled to the timer, and the switch is activatable by the food carrier for activating the heating source and the timer in response to positioning the food carrier in the toasting position in the toasting chamber. The switch is formed in the floor in a preferred embodiment. The heating source includes a wall of heat-insulative material, and resistance wire. The wall has a lower extremity, an upper extremity, and an inner face, the wall extends upright from the lower extremity connected to the floor to the upper extremity connected to the housing, and the inner face completely encircles the toasting chamber. The resistance wire is carried by the wall, and is uniformly distributed along the inner face of the wall for sourcing surrounding heat to the toasting chamber. In a particular embodiment, the resistance wire is arranged in spaced-apart parallel rows that extend upright along the inner face of the wall in concert with the wall. The wall is formed by a plurality of wall segments. Each wall segment is joined to an adjacent wall segment via a hinge, which is preferably a living hinge. Guides are formed in the top of the housing, which are for receiving and guiding a food carrier into the toasting chamber through the opening.

### BRIEF DESCRIPTION OF THE DRAWINGS

Referring to the drawings:

FIG. 1 is a perspective view of a toasting machine for toasting a food product and a food carrier positioned above the toasting machine in preparation for application into the toasting machine, the toasting machine and the food carrier each constructed and arranged in accordance with the principle of the invention;

FIG. 2 is a section view taken along line 2-2 of FIG. 1;

FIG. 3 is a front elevation view of the toasting machine of FIG. 1;

FIG. 4 is a side elevation view of the embodiment of FIG. 3;

FIG. 5 is a bottom plan view of the embodiment of FIG. 3;

FIG. 6 is a top plan view of the embodiment of FIG. 3;

FIG. 7 is a schematic representation of the embodiment of FIG. 1 illustrating a heating source as it would appear installed on a floor;

FIG. 8 is a front elevation view of the heating source of FIG. 7 shown as it would appear unfolded, the heating source including a wall, formed of wall segments, and resistance wire carried by the wall;

FIG. 9 is a rear elevation view of the embodiment of FIG. 8;

FIG. 10 is a perspective view of the heating source of FIGS. 8 and 9 shown as it would appear folded inwardly upon itself in preparation for assembly;

FIG. 11 is a view similar to that of FIG. 10 illustrating the heating source as it would appear assembled in preparation for installation on the floor as in FIG. 7;

FIG. 12 is an enlarged fragmented perspective view of the heating source of FIGS. 8-11 illustrating a hinge connecting adjacent wall segments of the wall of the heating source;

FIG. 13 is a section view taken along line 13-13 of FIG. 12;

FIG. 14 is an enlarged fragmented perspective view of contact assembly of the heating source of FIGS. 8-10 shown as it would appear disconnected;

FIG. 15 is a view similar to that of FIG. 14 illustrating the contact assembly as it would appear connected;

FIG. 16 is a top plan view of the embodiment of FIG. 7;

FIG. 17 is partially schematic, fragmented view of the heating source and the floor of FIG. 7, the heating source being shown in dotted outline as it would appear connected to the floor;

FIG. 18 is a vertical section view of the toasting machine and the food carrier of FIG. 1 illustrating the food carrier positioned in a toasting chamber in a toasting position in preparation for toasting food product, depicted in phantom outline, carried by the food carrier;

FIG. 19 is a vertical section view of a switch of the toasting machine of FIG. 1 shown as it would appear deactivated;

FIG. 20 is a view similar to that of FIG. 19 showing the switch as it would appear activated;

FIG. 21 is a perspective view of the food carrier of FIG. 1 shown as it would appear holding food product depicted in phantom outline;

FIG. 22 is a top plan view of the embodiment of FIG. 21;

FIG. 23 is a front elevation view of the embodiment of FIG. 21;

FIG. 24 is a side elevation view of the embodiment of FIG. 21;

FIG. 25 is a perspective view of an auxiliary food carrier shown as it would appear holding a food product depicted in phantom outline;

FIG. 26 is a top plan view of the embodiment of FIG. 25;

FIG. 27 is a front elevation view of the embodiment of FIG. 25;

FIG. 28 is a side elevation view of the embodiment of FIG. 25;

FIG. 29 is a section view taken along line 29-29 of FIG. 25;

FIG. 30 is a vertical section view similar to that of FIG. 18 illustrating the food carrier positioned in the toasting chamber in the toasting position in preparation for toasting a food product, depicted in phantom outline, carried by the auxiliary food carrier of FIG. 25 installed on the food carrier;

FIGS. 31 and 32 show a sequence of steps for installing the auxiliary food carrier of FIG. 25 on the food carrier first depicted in FIG. 1;

FIGS. 33 and 34 show a sequence of steps for removing food product from the food carrier of FIG. 21 with a specially-designed spatula; and

FIG. 35 is a perspective view of an alternate embodiment of a heating source for use with a toasting machine constructed and arranged in accordance with the principle of the invention.

### DETAILED DESCRIPTION

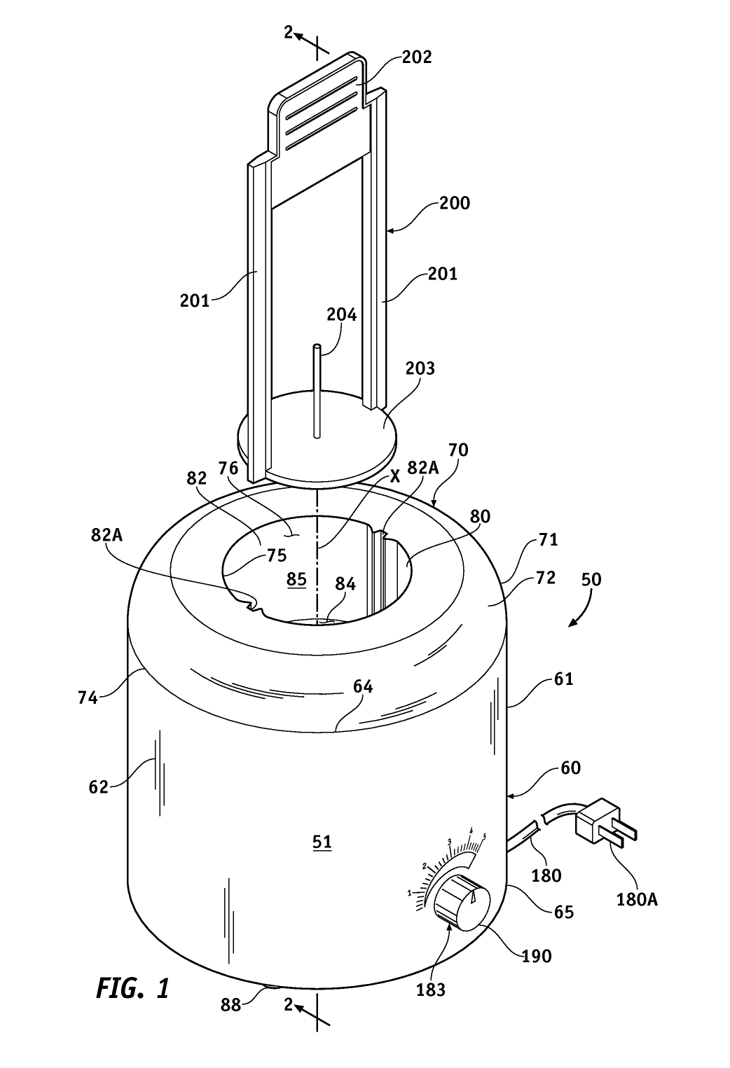

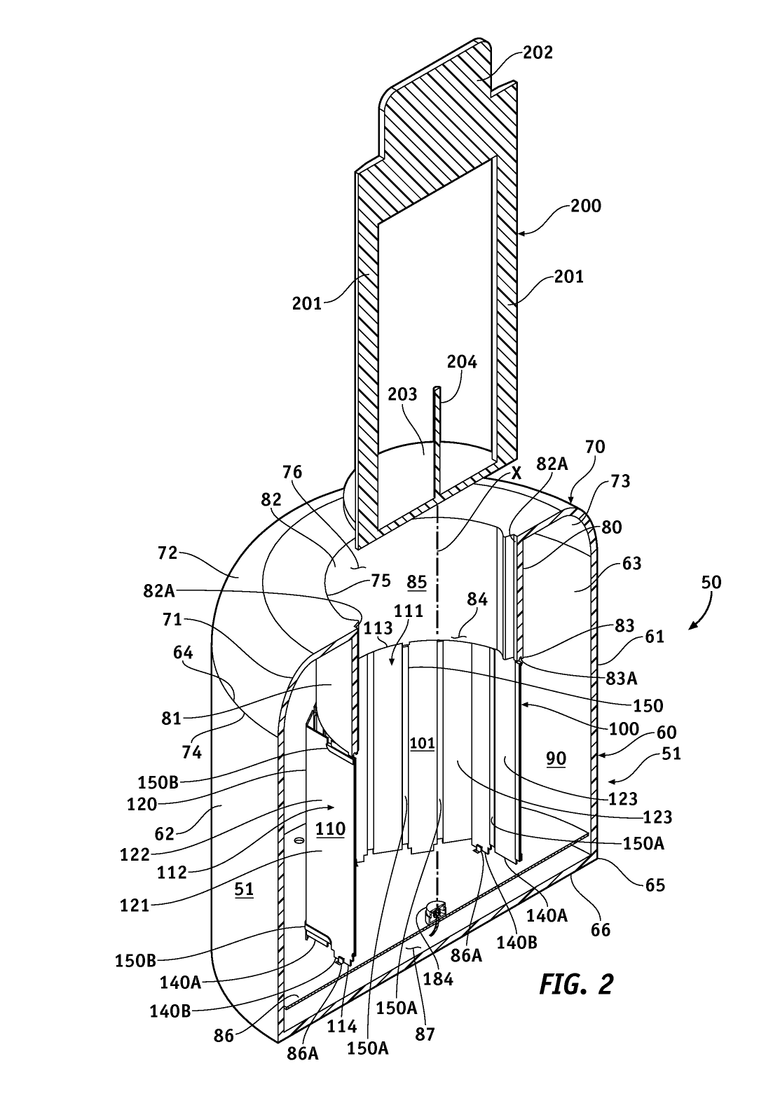

Turning now to the drawings, in which like reference characters indicate corresponding elements throughout the several views, attention is first directed to FIG. 1 and FIG. 2 in which there is seen a toasting machine 50 for toasting a food product, such as one or more marshmallows, rolls, pastries, etc. The terms “toasting” and “toast” each conventionally mean to brown, heat, or warm thoroughly, and the phrase “toasting a food product” conventionally means to brown, heat, or warm thoroughly the food product. Food carrier 200 adapted to be used with toasting machine is positioned above toasting machine 50 in FIG. 1 in preparation for application into toasting machine 50 for the purpose of toasting a food product held by food carrier.

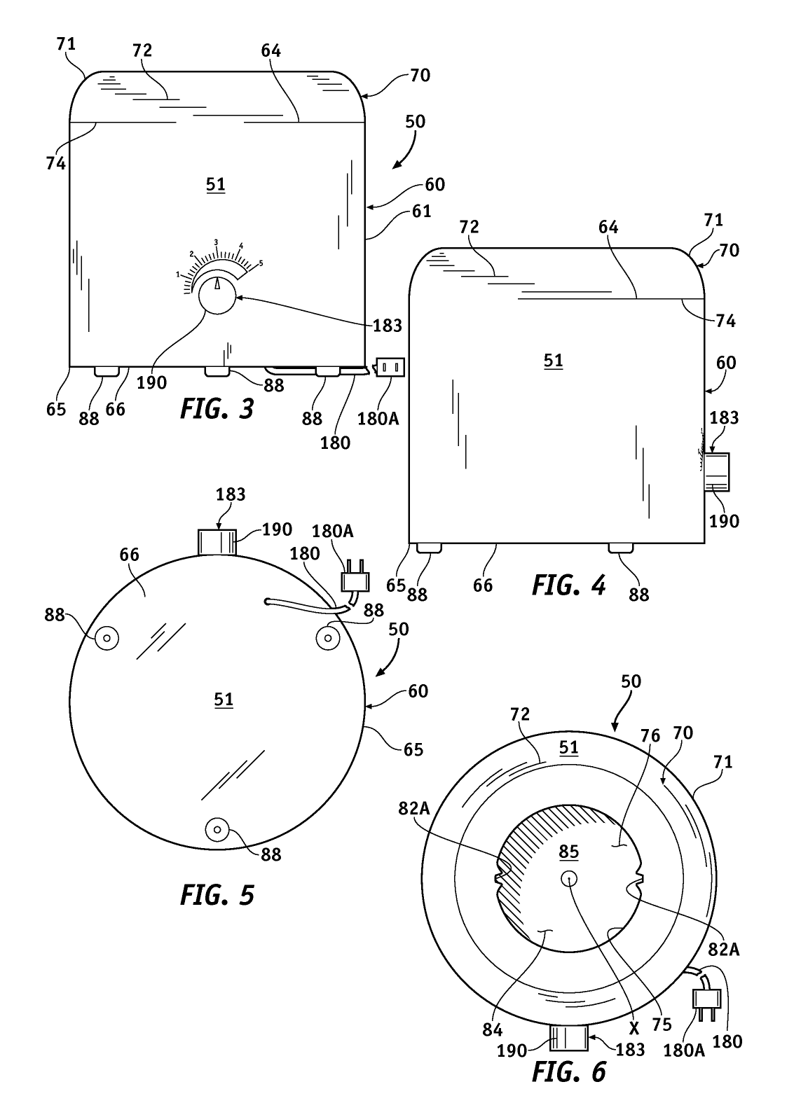

Toasting machine 50 includes housing 51. Housing 51 is the main support structure of toasting machine 50 and is formed of a material or a combination of materials having the properties of strength, rigidity, resilience, and resistance to heat, such as aluminum, steel, a metal composite, thermosetting plastic, or the like. Housing 51 includes vessel or container 60, and top 70. Container 60 and top 70 are arranged about axis X, which in this example is the geometric center of housing 51. Container 60 and top 70 are each integrally formed, such as by molding, injection molding, or machining, and in the alternative may be fashioned of a plurality of parts joined together with an adhesive, welding, heat bonding, or other joinery. For the purposes of illustration and reference, FIG. 3 is a front elevation view of toasting machine 50, FIG. 4 is a side elevation view toasting machine 50, FIG. 5 is a bottom plan view of toasting machine 50, and FIG. 6 is a top plan view of toasting machine 50.

Referring to FIGS. 1-6 and 18 in relevant part, container 60 includes continuous sidewall 61 having outer surface 62, inner surface 63, upper edge 64, lower edge 65, and horizontal bottom 66 affixed to lower edge 65. Top 70 is connected to upper edge 64. Continuous sidewall 61 is cylindrically-shaped in the present embodiment. Top 70 is an annular cap and includes continuous sidewall 71 having outer surface 72, inner surface 73, outer edge 74, and inner edge 75. Outer edge 74 is affixed to upper edge 64 of container 60 via an adhesive, welding, heat bonding, or other joinery. Continuous sidewall 71 extends upright from outer edge 74 and rounds inwardly to inner edge 75, which defines opening 76 in top 70 of housing 51. Bottom 66 and inner surface 63 of container 60 and inner surface 73 of top 70 cooperate to form volume 90, which is the contained space or the interior of housing 51 that houses certain components of toaster machine 50.

Top 70 is formed with collar 80. Collar 80 is cylindrically-shaped in the present embodiment and has outer surface 81 and inner surface 82. Collar 80 depends downwardly from inner edge 75 of top 70 into volume 90, and terminates in volume 90 with distal edge 83, which defines subjacent opening 84 in volume 90. Inner surface 82 of collar 80 defines passage 85 between opening 76 and subjacent opening 84, all of which are arranged about the geometric center of housing 51 of toasting machine 50 defined by axis X. Opening 76 leads to, i.e. communicates with, volume 90 via passage 85 and subjacent opening 84. Horizontal floor 86 in volume 90 is affixed to inner surface 63 of continuous sidewall 61 near bottom 66 and opposes top 70 via welding, heat bonding, an adhesive, or the like. Floor 86 is positioned above bottom 66 so as to form a space 87 therebetween. Floor 86 is part of housing 51 and is made of the same heat-resistant material as that of housing 51.

Supporting feet 88, fashioned of rubber or plastic, are secured to the outside of bottom 66, such as with an adhesive, double-sided-tape, screws, or the like, and support toasting machine 50 on a supporting surface, such as a table or a countertop. Three supporting feet 88 are employed in the present embodiment as shown in FIGS. 3 and 5, and more or less such supporting feet 88 can be used without departing from the invention.

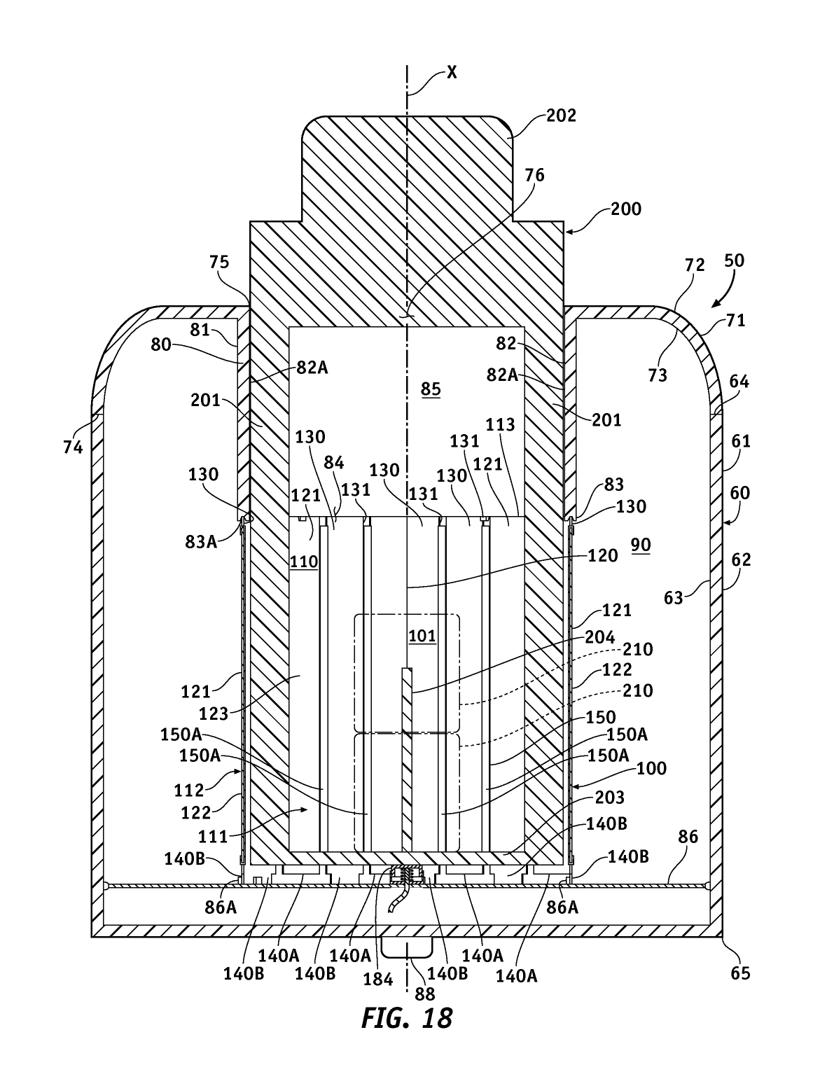

In FIGS. 2 and 18, toasting machine 50 includes heating source 100 for toasting a food product in the interior of housing 51, namely, volume 90. Heating source 100 is mounted in volume 90 and extends upright in a direction from floor 86 and bottom 66 of housing 51 to top 70 of housing 51, and completely encircles toasting chamber 101 in volume 90 of housing 51 for sourcing surrounding heat to toasting chamber 101 for toasting a food product applied to toasting chamber 101. Heating source 100 and toasting chamber 101 are subjacent to, or otherwise positioned underneath, subjacent opening 84, passage 85, and opening 76, respectively, and are arranged about axis X in concert with subjacent opening 84, passage 85, opening 76, and, moreover, housing 51. In other words, opening 76, passage 85, subjacent opening 84, and toasting chamber 101 are coaxial in that they share and are arranged about axis X, which, as explained above, is the geometric center of housing 51. Opening 76 in top 70 of housing 51 communicates with toasting chamber 101 via passage 85 and subjacent opening 84 for admitting a food product downwardly into toasting chamber 101 for toasting through the exposure of surrounding heat supplied by heating source 100.

Heating source 100 includes wall 110 and resistance wire 150 carried by wall 110. Wall 110 is chemically inert, dielectric, flexible so as to be capable of being flexed and bent, lightweight, resilient, flame-resistant and heat-insulative, being stable when exposed to extreme temperatures. Wall 110 is thus constructed of a material or combination of materials having these properties. In a preferred embodiment, wall 110 is fashioned of mica and is thus exemplary of a mica sheet.

In FIGS. 8-10 in relevant part, wall 110 has inner face, denoted generally at 111, outer face, denoted generally at 112, and opposed upper and lower extremities 113 and 114 that extend between opposed side extremities 115 and 116. A plurality of equally spaced-apart hinges 120 between side extremities 115 and 116 extends from upper extremity 113 to lower extremity 114. Hinges 120 divide wall 110 into joined adjacent wall segments 121 each having an outer surface 122 and an inner surface 123. Wall segments 121 are planar and are substantially equal in overall size and shape. Outer surfaces 122 of wall segments 121 cooperate to define outer face 112 of wall 110, and inner surfaces 123 of wall segments 121 cooperate to define inner face 111 of wall 110.

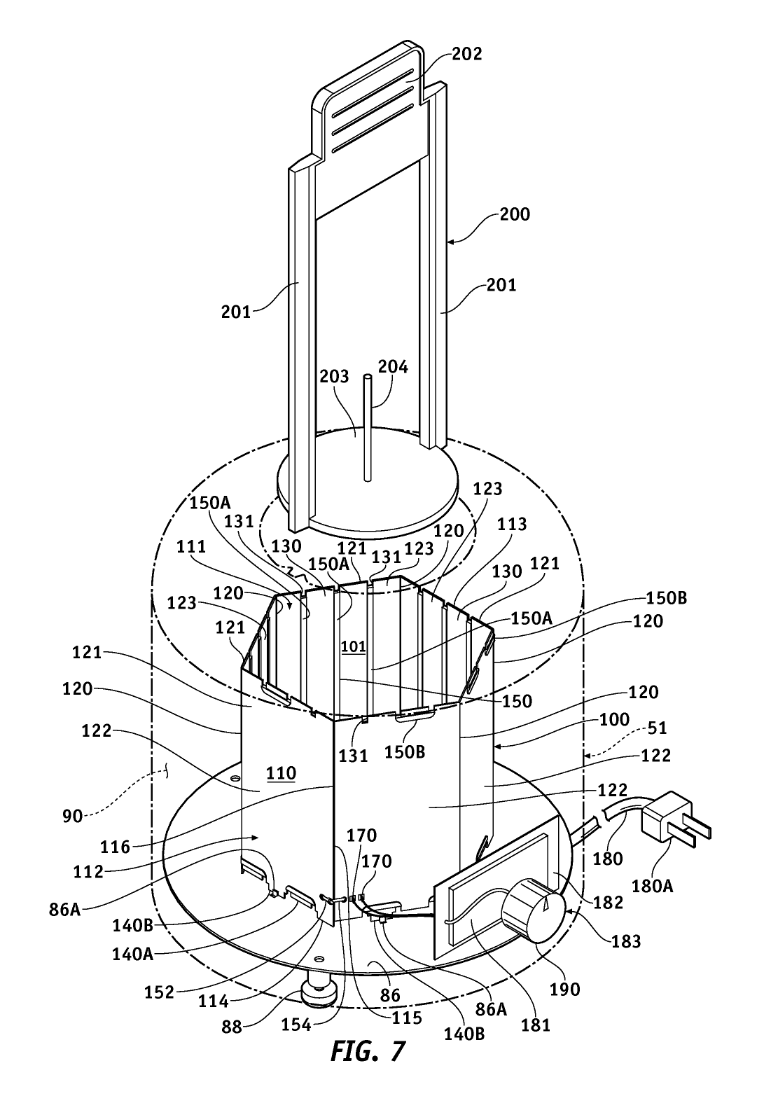

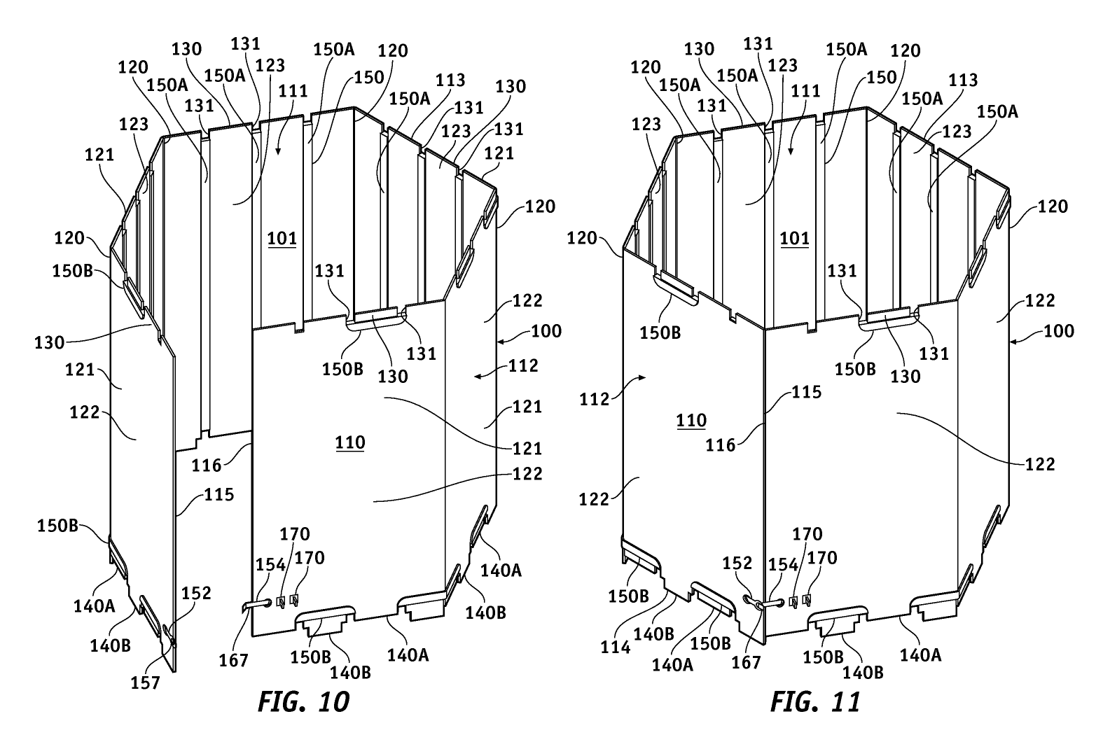

Each wall segment 121 is joined to an adjacent wall segment 121 via a hinge 120 to enable the folding of each wall segment 121 relative to an adjacent wall segment 121, and further to enable wall 110 to be folded inwardly as shown in FIG. 10 so as to bring side extremities 115 and 116 together in contact with one another to configure wall into a ring or annulus, as in FIGS. 7 and 11. In this annulus formation of wall 110 shown in FIGS. 7 and 11, wall 110 is made into an upright, continuous wall 110 of wall segments 121, including outer surfaces 122 and hinges 120 that cooperate to define continuous outer face 112, inner surfaces 123 and hinges 120 that cooperate to define continuous inner face 111 that completely encircles toasting chamber 101 denoted in FIGS. 2, 7, 11, 16, and 18, continuous upper extremity 113, and continuous lower extremity 114. In this embodiment, wall 110 includes five hinges 120 that join six wall segments 121. With this configuration, the overall shape of wall 110 in its annulus formation is hexagonal including six equal wall segment 121 sides and six equal angles.

Each hinge 120 joining each wall segment 121 to an adjacent wall segment 121 is a living hinge formed in the material of wall 110. FIG. 12 is an enlarged fragmented perspective view of heating source 100 illustrating hinge 120 connecting adjacent wall segments 121 of wall 110, and FIG. 13 is a section view taken along line 13-13 of FIG. 12 further illustrating hinge 120 connecting adjacent wall segments 121 of wall 110.

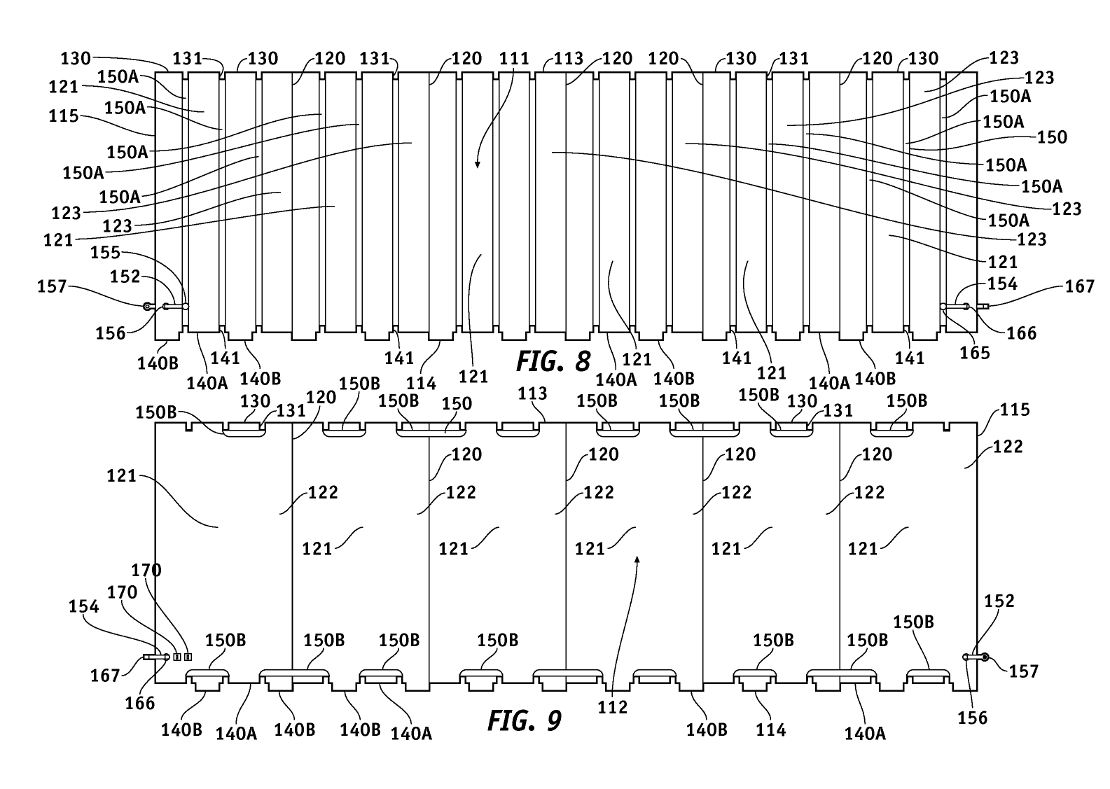

In FIGS. 8 and 9, alternating tabs 130 and notches 131 are formed in upper extremity 113 of wall 110. In this embodiment, each wall segment 121 has four tabs 130 and three equally spaced-apart notches 131. Alternating tabs 140 and notches 141 are formed in lower extremity 114, and are in vertical alignment with respect to the corresponding tabs 130 and notches 131 of upper extremity 113. Tabs 140 consist of alternating inner tabs 140A and outer tabs 140B. Each wall segment 121 has two inner tabs 140A, two outer tabs 140B, and three equally spaced-apart notches 141. Outer tabs 140B extend outwardly with respect to inner tabs 140A, which are inboard with respect to outer tabs 140B.

Resistance wire 150 is the heating element of heating source 100 and operates to provide surrounding heat to toasting chamber 101 for toasting a food product lowered into toasting chamber 101 through opening 76, passage 85, and subjacent opening 84 denoted in FIGS. 2 and 18. With continuing reference in relevant part to FIGS. 8 and 9, resistance wire 15 is a strand of wire, which, in the present embodiment, consists of a strand of nichrome wire. Inner lengths 150A of resistance wire 150 extend along inner face 111 of wall 110 as shown in FIG. 8, and outer lengths 150B of resistance wire 150 extend along outer face 112 of wall 110 as shown in FIG. 9.

The inner lengths 150A of resistance wire 150 extend upright along inner face 111 of wall 110 between each pair of vertically-aligned notches 131 and 141 in the respective upper and lower extremities 113 and 114 of wall 110. Resistance wire 150 is applied through each pair of vertically-aligned notches 131 and 141 to the outer lengths 150B of resistance wire 150. Each outer length 150B of resistance wire at upper extremity 113 of wall 110 extends between adjacent notches 131 of upper extremity 113 and is hooked/wrapped around the outer face 112 side of the corresponding tab 130 therebetween, as shown in FIG. 9. Each outer length 150B of resistance wire 150 along outer face 112 of wall 110 at upper extremity 113 of wall 110 extends between adjacent notches 131 in a direction that is transverse relative to the upright direction of the inner lengths 150A of resistance wire 150 along inner face 111 of wall 110. Each outer length 150B of resistance wire 150 at lower extremity 114 of wall 110 extends between adjacent notches 141 of lower extremity 114 and is hooked/wrapped around the outer face 112 side of the corresponding inner tab 140A therebetween, as shown in FIG. 9. Each outer length 150B of resistance wire 150 along outer face 112 of wall 110 at lower extremity 114 of wall 110 extends between adjacent notches 141 in a direction that is transverse and orthogonal relative to the upright direction of the inner lengths 150A of resistance wire 150 along inner face 111 of wall 110.

The inner lengths 150A of resistance wire 150 that extend along inner face 111 of wall are equal in length from upper extremity 113 to lower extremity 114 and are arranged in spaced-apart parallel rows that extend upright along inner face 111 of wall 110 from lower extremity 114 to upper extremity 113 in concert with wall 110. Inner lengths 150A of resistance wire 150 are orthogonal relative to upper and lower extremities 113 and 114, and are parallel relative to side extremities 115 and 116. Outer lengths 150B of resistance wire 150 are parallel relative to upper and lower extremities 113 and 114, and are orthogonal with respect to side extremities 115 and 116. Each wall segment 121 has a plurality of inner lengths 150A, namely, three inner lengths 150A, of resistance wire 150 that extend along inner surface 123 thereof. The three inner lengths 150A of resistance wire 150 of each wall segment 121 are parallel relative to each other and equally spaced-apart.

According to this discussion, resistance wire 150 is wrapped onto wall 110 so as to form spaced-apart, upright, parallel inner lengths 150A of resistance wire along inner face 111 of wall 110 from side extremity 115 to side extremity 116 as shown in FIG. 8, and alternating upper and lower outer, transverse outer lengths 150B of resistance wire along outer face 112 of tabs 130 and 140 of wall 110 that extend in a direction from side extremity 115 to side extremity 116 as shown in FIG. 9, whereby one such outer length 150B passes across each hinge 120 connecting adjacent wall segments 121. In the annulus configuration of wall 110 shown in FIGS. 2, 7, and 11, the above-described arrangement of the inner lengths 150A of resistance wire along the inner surfaces 123 of the respective wall segments 121 that together form inner face 111 of wall 110 forms a uniform distribution of resistance wire 150 along inner face 111 of wall 110 for sourcing surrounding heat uniformly to toasting chamber 101 to provide uniform toasting heat around a food product positioned in toasting chamber 101.

In FIG. 8, the outermost inner lengths 150A of resistance wire 150 near side extremities 115 and 116 are formed with electrical contacts 152 and 154, respectively. Contacts 152 and 154 form a contact assembly of heating source 100 and are adapted to be connected together to convert resistance wire 150 into a continuous loop in preparation for being energized to generate heat. Contacts 152 and 154 are each made of the same resistance wire material as resistance wire 150. Contact 152 is formed at side extremity 115 of wall 110 near lower extremity 114, and contact 154 is formed at side extremity 116 of wall 110 near lower extremity 114. With this positioning, contacts 152 and 154 are diametrically opposed in the annulus formation of wall 110 and readily interconnected.

Contact 152 is connected to the outermost inner length 150A of resistance wire 150 nearest to side extremity 115 with screw terminal 155, extends outwardly from screw terminal 155 toward side extremity 115 through eyelet 156 in wall 110 from inner face 111 to outer face 112, and extends outwardly from eyelet 156 beyond side extremity 115 to connecting end 167. Contact 154 is connected to the outermost inner length 150A of resistance wire 150 nearest to side extremity 116 with screw terminal 165, extends outwardly from screw terminal 165 toward side extremity 116 through eyelet 166 in wall 110 from inner face 111 to outer face 112, and extends outwardly from eyelet 166 beyond side extremity 115 to connecting end 167. In the annulus formation of wall 110 shown in FIGS. 7 and 11, connecting ends 157 and 167 of contacts 152 and 154 are juxtaposed with respect to each other, as shown in FIG. 14, and are then interconnected, as shown in FIG. 15, making resistance wire 150 continuous in preparation for taking on an electric load for generating heat. The application of contact 152 through eyelet 156 from inner face 111 to outer face 112 and the application of contact 152 through eyelet 166 from inner face 111 to outer face 112 locates connecting ends 157 and 167 along the outer face 112 of wall 110 in the annulus formation of wall, which allows a user to easily take up contacts 152 and 154 and connect them together as described below.

Connecting end 157 is a female element in the form of a ring, and connecting end 167 is a male element in the form of a hook. To connect connecting ends 157 and 167 together in the annulus formation of wall 110, the hook forming connecting end 167 is simply hooked through the ring forming connecting end 157 as shown in FIG. 15. To disconnect connecting ends 157 and 167, connecting end 167 need only be unhooked from connecting end 157. In the annulus formation of wall 110 shown in FIGS. 7 and 11 and with contacts 152 and 154 connected as shown in FIGS. 7 and 11, heating source 100 is fully assembled and ready to be put to use in conjunction with toasting machine 50. A conventional, positive and negative two-point electrical contact 170, shown in FIGS. 7, 8, 10, 11, and 12, is used to electrically connect resistance wire 150 to an electric load. In this embodiment, electrical contact 170 is electrically connected to contact 154 for electrically connecting resistance wire 150 to an electrical load. Electrical contact is located on outer face 112 of wall 110 near contact 154.

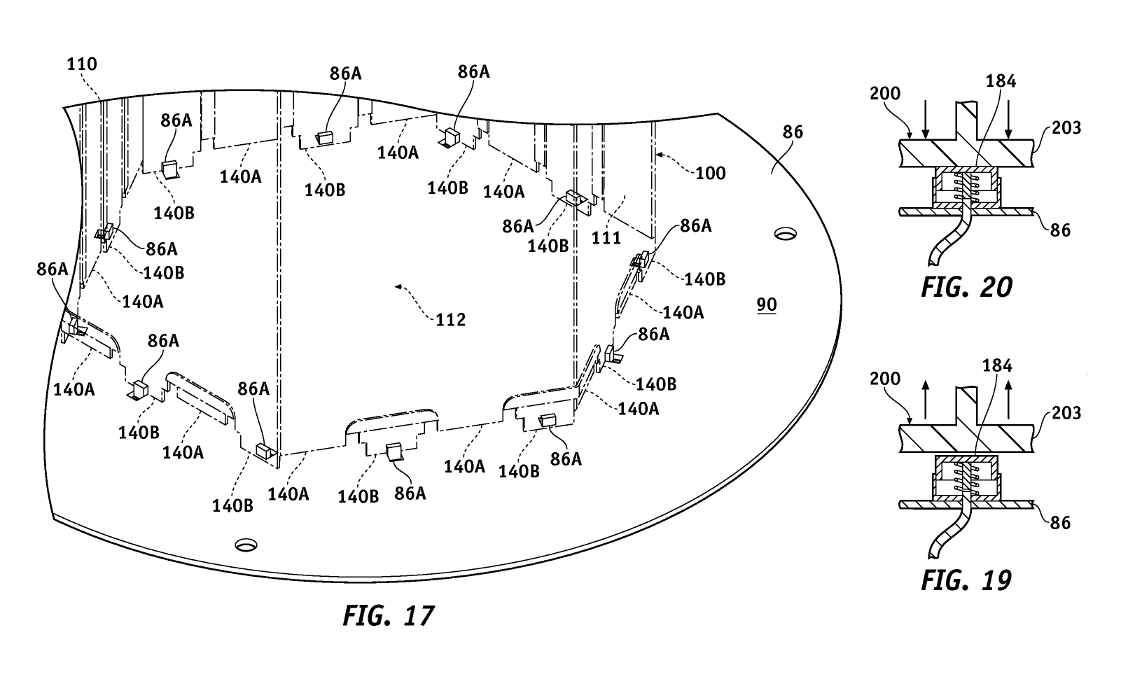

Referring in relevant part to FIGS. 2, 7, 16, 17, and 18, the assembled and formed heating source 100 of FIG. 11 is mounted in volume 90 on floor 86. Wall 110 extends upright from lower extremity 114 in contact with floor 86 to upper extremity 113 in a direction from floor 86 of housing 51 to distal edge 83 of housing 51 as best shown in FIGS. 2 and 18. Wall 110 of heating source 100 is connected between floor 86 and housing 51 in volume 90 and, again, extends upright in a direction from bottom 66 to top 70. Specifically, lower extremity 114 is connected to floor 86, and upper extremity 113 is connected to distal edge 83 of collar 80 of top 70 of housing 51. Wall 110 is captively retained between floor 86 of housing 51 and distal edge 83 of collar 80 of top 70 of housing 51.

In this embodiment, outer notches 140B are positioned directly against floor 86. This holds upper inner notches 140 above floor 86, including outer lengths 150B of resistance wire, which keeps outer lengths 150B of resistance wire 150 wrapped around tabs 140 above and out of contact from floor 86. A pattern of upturned tabs 86A is formed in floor 86. Tabs 86 abut directly against the inner face 111 and the outer face 112 of alternating outer tabs 140B, respectively, which releasably connects, retains, and seats lower extremity 114 in place on floor 86 in volume 90 of housing 51. A groove 83A is formed in distal edge 83. A tab 130 of each wall segment 121 of wall 110 is applied to groove 83A so as to be keyed into groove 83A, which releasably connects, retains, and seats upper extremity 113 in place to top 70 of housing 51 in volume 90. The flexibility of wall 110 allow tabs 130 be flexed to conform to the curvature of groove 83A in edge 83A of collar 80. And so the tab 130 of each wall segment 121 is forced into groove 83A, and is flexed to conform to the curvature of groove 83A in edge 83A of collar 80. The connecting points of heating source 100 to housing 51 can be fortified with a heat-sensitive adhesive, if so desired.

So installed in volume 90 of housing 51, heating source 100 completely encircles toasting chamber 101 in volume 90 of housing 51 and is operative for sourcing surrounding heat to toasting chamber 101, and heating source 100, including wall 100 and resistance wire 150, and toasting chamber 101 defined by heating source 100, are arranged about axis X. Again, heating source 100 and toasting chamber 101 are subjacent to subjacent opening 84, passage 85, and opening 76, and are arranged about axis X in concert subjacent opening 84, passage 85, opening 76, and, moreover, housing 51. Opening 76 in top 70 of housing 51 thereby communicates with toasting chamber 101 via passage 85 and subjacent opening 84 for admitting a food product into toasting chamber 101 defined by heating source 100 for toasting through the exposure of surrounding heat from heating source 100.

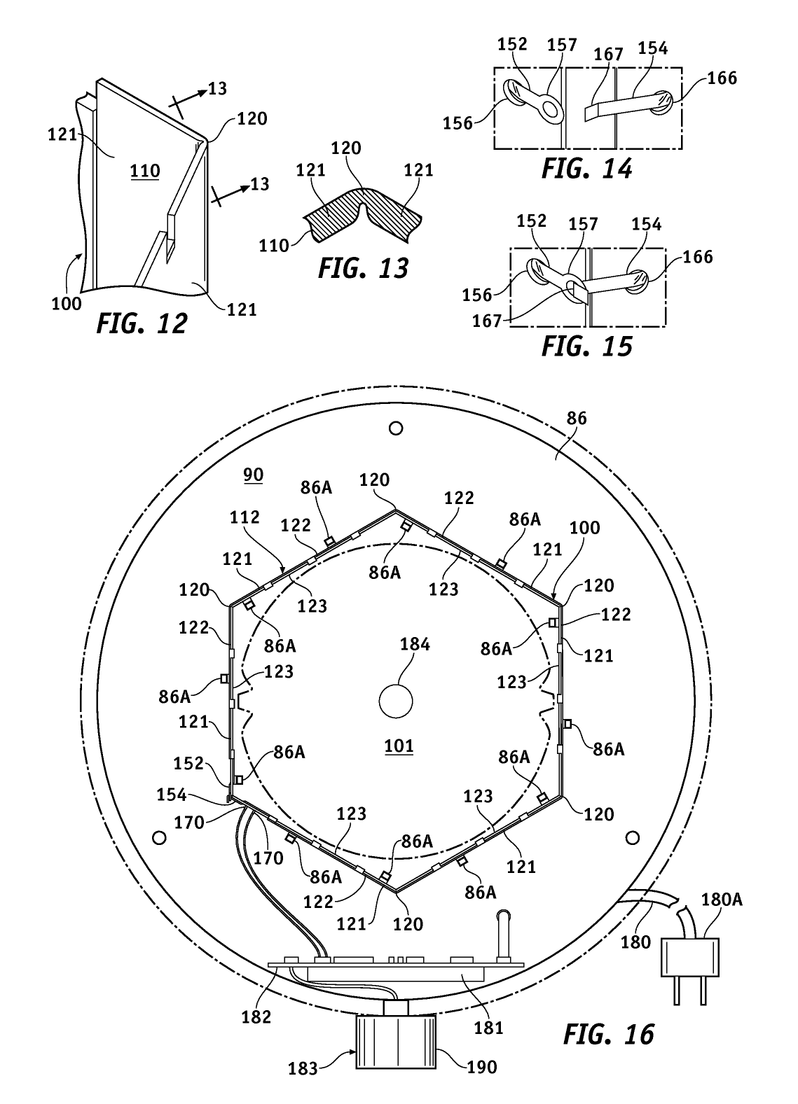

In FIG. 16, toasting machine 50 includes power cord 180, power supply 181, circuit board 182, timer 183, and switch 184, each of which is conventional. Conventional electrical wiring electrically connects power cord 180 to power supply 181, electrically connects power supply 181 to circuit board 182, and electrically connects circuit board 182 to heating source 100, timer 183, and switch 184. Conventional electrical wiring is also used to electrically connect circuit board 182 to electrical contact 170 of heating source 100 for energizing resistance wire 150 to cause resistance wire 150 to generate heat for toasting a food produce lowered into toasting chamber 101 in the operation of toasting machine 50. Power cord 182 has a conventional plug 180A that plugs into a conventional 120V alternating current power outlet for providing power to toasting machine 50 via power supply 181, which is a conventional 120V power supply. Power supply 181 and circuit board 182 are mounted in volume 90 of housing 51 on floor 86, such as with brackets or connectors or the like, between inner surface 63 of continuous sidewall 61 and outer face 112 of heating source 100. The heat-insulative property of wall 110 insulates that part of volume 90 between outer face 112 of wall 110 and inner 63 of container 60 of housing from the heat generated in toasting chamber 101 from heating source 100 so as to prevent heat damage to power supply 181 and circuit board 182 and the associated electrical wiring. Power cord 180 extends from power supply 181 in volume 90 of housing 51 through floor 86 and bottom 66 and outwardly from bottom 66 to plug 180A for plugging into an outlet.

Switch 184 is a conventional and well-known spring-actuated toggle switch and is mounted in floor 86 at the geometric center of toasting chamber 101 defined by axis X. Switch 184 is operatively coupled to timer 183 via a toasting circuit. Switch 184 opens and closes the toasting circuit between, on the one hand, circuit board 182 and, on the other hand, heating source 100 and timer 183. Upon turning switch 184 ON, the toasting circuit closes activating timer 183 preset to a preselected toasting time and heating source 100, which energizes resistance wire 150 for sourcing surrounding heat to toasting chamber 101 for the preselected toasting time. The toasting circuit remains closed until timer 183 times out at the close of the preselected toasting time, opening the toasting circuit deactivating heating source 100 and timer 183. While the toasting circuit remains closed, resistance wire 150 remains energized and applies persistent surrounding heat to toasting chamber 101 for toasting a food product lowered into toasting chamber 101. Only by switching switch 184 OFF and then ON again can the toasting circuit again be closed for toasting a food product. The inherent physical properties of wall 110 discussed above allow wall 110 to withstand the heat generated by resistance wire 150, and to resist catching fire.

In this embodiment, timer 183 is a conventional electromechanical timer 183, whereby a simple circuit acts as a timer in conjunction with the operation of a rotating knob 190 of timer 183. Rotating knob 190 is mounted on the outer surface 62 of housing 51 so as to be readily accessible by hand, and may be adjusted via rotation to operate toasting machine 50 for toasting a food product for preselected toasting periods of time, such as one minute, two minutes, three minutes, four minutes, five minutes, and fractions thereof. The toasting circuit is defined by a capacitor of circuit board 182 that forms part of timer 183 and which charges through a resistor of circuit board 182, and when it reaches a certain voltage it cuts off the power to heating source 100 and timer 183. This characterizes a conventional and well-known electro-mechanical timer 183, the details of which will readily occur to those having ordinary skill.

To apply a food product to toasting chamber 101 for toasting, the food product is lowered through passage 85 from opening 76 to subjacent opening 84 in top 70 of housing 51 and into toasting chamber 101 from subjacent opening 84. Food carrier 200 is used to hold and maneuver a food product into toasting chamber 101 for toasting. Food carrier 200 is a fixture and is formed of a material or a combination of materials having the properties of strength, rigidity, resilience, and resistance to heat, such as aluminum, steel, a metal composite, a plastic composite, or the like. Food carrier 200 is integrally formed, such as by molding, injection molding, or machining, and in the alternative may be fashioned of a plurality of parts joined together with an adhesive, welding, heat bonding, or other joinery.

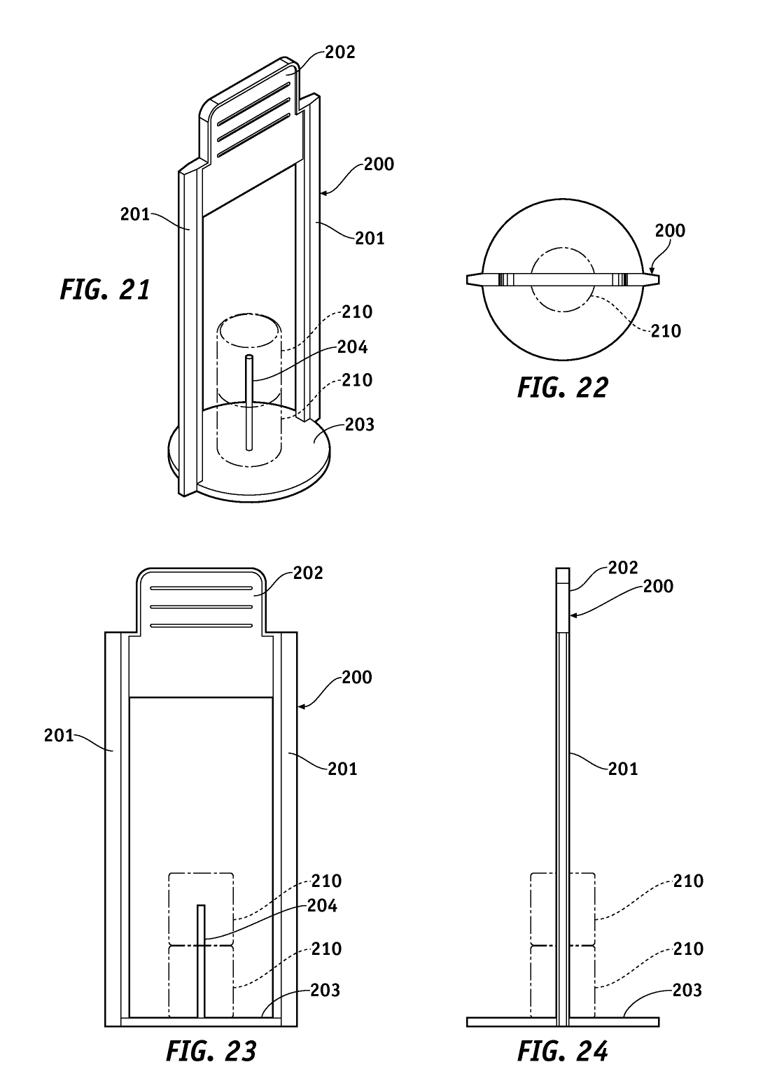

Referring to FIGS. 1, 2, 7, 18, and 21-24 in relevant part, food carrier 200 consists of opposed, parallel posts 201 that connect a handle 202 at an upper or handled end of food carrier 200, and a platform 203, having a central, upstanding skewer 204, at a lower end of food carrier 200. Food product, such as marshmallows 210 shown in phantom outline in FIG. 18 and FIGS. 21-24, are impaled on skewer 204, one atop the other, with the lowermost marshmallow 210 positioned directly atop platform 203. In this example, marshmallows 210 are each standard-sized having a height of approximately 1⅛ inches and a diameter of approximately 1 inch.

To toast marshmallows 210 with toasting machine 50, knob 190 is set to a preselected toasting time, such as one minute, two minutes, three minutes, or other preselected time. Food carrier 200 is taken up by hand, such as at handle 202, is initially positioned above opening 76 of toasting machine 50 (see FIGS. 1 and 2) in preparation for lowering into toasting chamber 101 into a toasting position for toasting marshmallows 210, and is then lowered platform 203 first into toasting chamber 101 toward floor 86 via opening 76, passage 85, and subjacent opening 85, until the underside of platform 203 contacts switch 184 mounted to floor 86, at which point food carrier 200 is released allowing it to come to rest in its toasting position in toasting chamber 101 for positioning marshmallows 210 in toasting chamber 101 in preparation for toasting, in which the underside of platform 203 comes to rest directly against and atop switch 184, which depresses switch 184 from its OFF position as in FIG. 19, to its ON position as in FIG. 20. The inherent weight of food carrier 200, which is about 500 grams in this example, is sufficient to depress switch 184 from its OFF position shown in FIG. 19 to its ON position shown in FIG. 20. In this toasting position of food carrier 200, skewer 204 is arranged about axis X and is thus centered in toasting chamber 101 and marshmallows 210 impaled on skewer 204 over platform 203 are held in the center of toasting chamber 101 for toasting. Once switch 184 is depressed, the toasting circuit closes activating heating source 100, which energizes resistance wire 150 for sourcing surrounding heat to toasting chamber 101 for toasting marshmallows 210 held by food carrier 200 in toasting chamber 101. The toasting circuit stays closed until timer 183 times out at the close of the preselected toasting time opening the toasting circuit, which de-activates heating source 100 and timer 183. The surrounding heat sourced to toasting chamber 101 from inner lengths 150A of resistance wire 150 on the inner surfaces 123 of wall segments 121 encircling toasting chamber 101 and marshmallows 210 in toasting chamber provide uniform/even toasting of marshmallows 210 applied to toasting volume 101 so as to produce uniformly or evenly toasted marshmallows 210, without the need to rotate the food product, whether manually or with a mechanical rotation device or rotisserie. Also, as marshmallows 210 melt during the toasting platform 203 under marshmallows 210 collects the marshmallow drippings and prevents such drippings from falling into the bottom of toasting machine 50. With the toasting of marshmallows 210 complete, handle 202 may be taken up, such as by hand, and food carrier 200, along with marshmallows 210, raised out of housing 51, at which point marshmallows 210, now toasted, may be removed from skewer 204 and consumed or assembled with other ingredients according to a preselected recipe. To remove marshmallows 210 with reference in relevant part to FIGS. 33 and 34, a broad, flat, flexible, bifurcated blade 216 of spatula 215 may be inserted between platform 203 and the underside of the lowermost marshmallow 210 while concurrently inserting skewer 204 into bifurcation 216A of blade 216, and spatula 215 may then be raised to dis-impale marshmallows 210 from skewer 204 as in FIG. 34.

Timer 183 may be configured to issue a light and/or a sound at the completion of a toasting time to indicate toasting is complete. Again, while the toasting circuit remains closed, resistance wire 150 remains energized and applies persistent surrounding heat to toasting chamber 101 for toasting a food product lowered into toasting chamber 101 for the duration of the preselected toasting time. Only by switching switch 184 OFF, such as by removing food carrier 200 from toasting chamber 101, and then ON again, such as by lowering food carrier 200 back into toasting chamber 101 to toast another food product, can the toasting circuit again be closed to repeat the toasting procedure. The surrounding heat sourced to toasting chamber 101 from inner lengths 150A of resistance wire 150 on the inner surfaces 123 of wall segments 121 encircling toasting chamber 101 and the food product in toasting chamber provide uniform/even toasting of food product applied to toasting volume 101 as herein described so as to produce an evenly toasted food product, without the need to rotate the food product, whether manually or with a mechanical rotation device or rotisserie.

To assist in applying food carrier 200 into toasting machine 50 though top 70 and into its toasting position in toasting chamber 101 as in FIG. 18, housing 51 is formed with opposed guides 82A. Guides 82A are formed in inner surface 82 of collar 80 as shown in FIGS. 1, 2, 6, and 18. Guides 82A receive food carrier 200 and assist in guiding food carrier 200 into toasting machine 50 through opening 76, passage 85, and subjacent opening 84, respectively. Referring to FIGS. 1, 2, 6, and 18 in relevant part, guides 82A are elongate slots, which are identical and diametrically opposed and which extend along inner surface 82 at either side of collar 80 from opening 76 to subjacent opening 84. Guides 82A relate to posts 201 of food carrier 200 so as to concurrently, slidably receive the respective posts 201. When food carrier 200 is inserted into toasting machine 50, posts 201 are concurrently applied to and are concurrently slid in and along guides 82A, which assist in guiding and lowering food carrier 200 platform 203 first into toasting chamber 101 via opening 76, passage 85, and subjacent opening 84 to position food carrier 200 in its toasting position, and which arrest food carrier 200 from rotation about axis X.

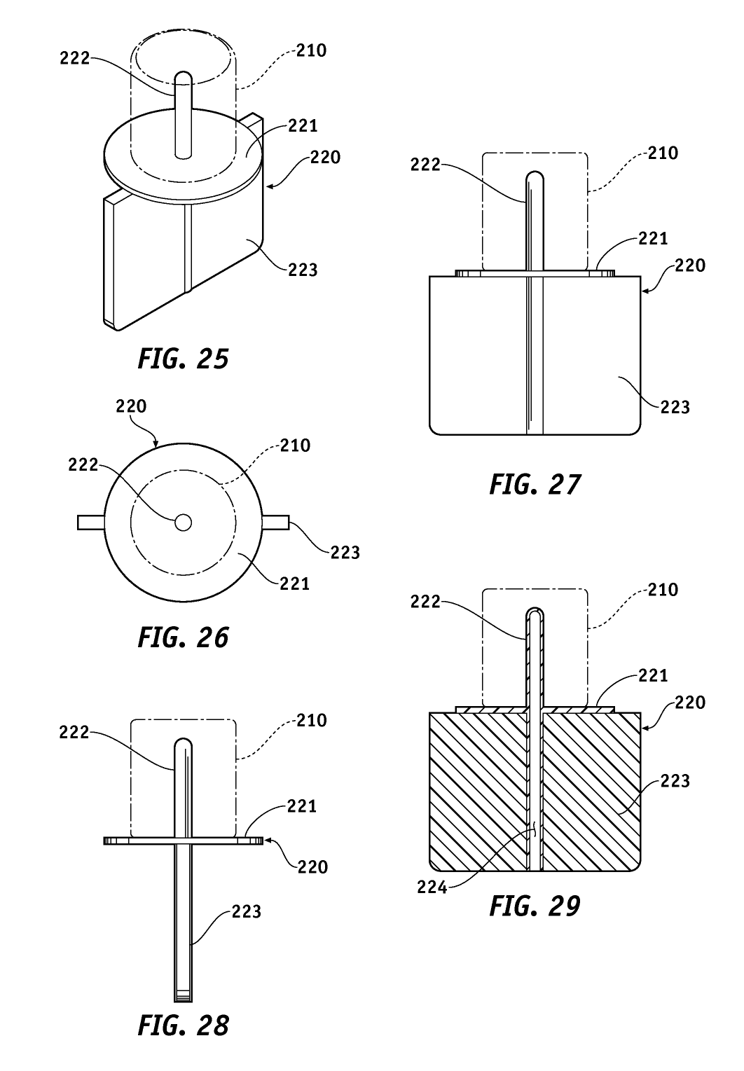

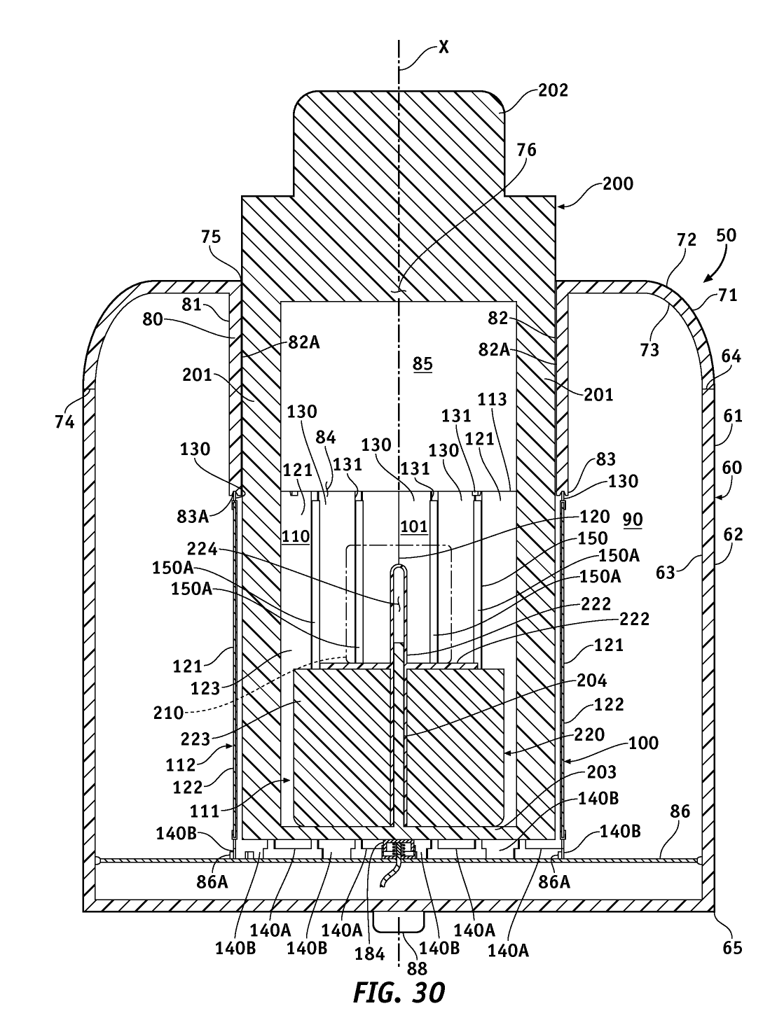

Reference is now made to FIGS. 25-29 and 30, which illustrate an auxiliary food carrier 220 useful in conjunction with the previously-described food carrier 200 for applying a food product to toasting chamber 101 for toasting. Like food carrier 200, auxiliary food carrier 220 is formed of a material or a combination of materials having the properties of strength, rigidity, resilience, and resistance to heat, such as aluminum, steel, a metal composite, a heat resistant plastic composite, or the like. Auxiliary food carrier 220 is a fixture and is integrally formed, such as by molding, injection molding, or machining, and in the alternative may be fashioned of a plurality of parts joined together with an adhesive, welding, heat bonding, or other joinery. Auxiliary food carrier 220 consists of a platform 221, having a central, upstanding skewer 222, which is positioned atop upstanding base 223. A hollowing 224, shown in FIGS. 29 and 30, is formed in auxiliary food carrier 220, which extends upwardly concurrently through base 223 and through platform 221 and into skewer 222. A food product, such as marshmallow 210 shown in phantom outline in FIGS. 25-30, is impaled on skewer 222 and is lowered directly atop platform 221 in preparation for toasting.

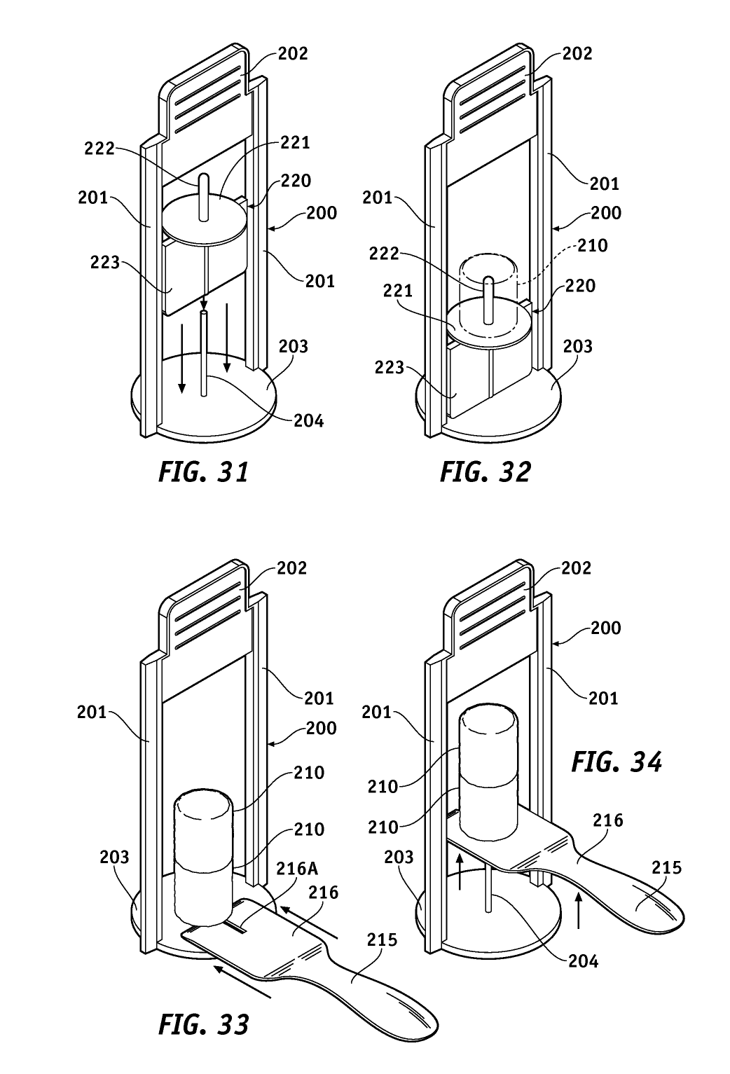

To toast marshmallows 210 with toasting machine 50, knob 190 is set to a preselected toasting time, such as one minute, two minutes, three minutes, or other selected time. Auxiliary food carrier 220 is taken up, such as by hand, and fitted onto food carrier 200 as shown in FIG. 30. Auxiliary food carrier 220 holding marshmallow 210 is applied upright over skewer 204 between posts 201 as shown in FIG. 31, skewer 204 is applied into hollowing 224 through base 223, and auxiliary food carrier 220 is lowered onto platform 204 as shown in FIG. 32, whereby base 23 is positioned atop platform 203 and skewer 204 is slid into hollowing 204 through base 223 and skewer 222 as shown in FIG. 30, which holds auxiliary food carrier 220 in place on platform 203 of food carrier 200. With auxiliary food carrier 220 so installed on food carrier 200, base 223 holds platform 221 at an elevated location relative to platform 203 of food carrier 200, and platform 221 and skewer 222, in turn, hold marshmallow 210 at an elevated location relative to platform 203 of food carrier 200. Food carrier 200 is then lowered into toasting machine 50 into its toasting position described above activating switch 184, i.e., turning switch 184 ON for toasting marshmallow 210. In this toasting position of food carrier 200 and auxiliary food carrier 220, skewers 204 and 222 are arranged about axis X and are thus centered in toasting chamber 101 and marshmallow 210 impaled on skewer 222 over platform 221 is held in the center of toasting chamber 101 at an elevated location for toasting. Again, the surrounding heat sourced to toasting chamber 101 from inner lengths 150A of resistance wire 150 on the inner surfaces 123 of wall segments 121 encircling toasting chamber 101 and marshmallows 210 in toasting chamber provide uniform/even toasting of marshmallows 210 applied to toasting volume 101 as herein described so as to produce uniformly or evenly toasted marshmallows 210, without the need to rotate the food product, whether manually or with a mechanical rotation device or rotisserie. Also, as marshmallow 210 melt during the toasting platform 221 under marshmallow 210 collects the marshmallow drippings and prevents such drippings from falling into the bottom of toasting machine 50. After the toasting is complete, handle 202 may be taken up, such as by hand, and food carrier 200, along with marshmallow 210 and auxiliary food carrier 220, raised out of housing 51, at which point marshmallow 210, now toasted, may be removed from skewer 222 and consumed. Marshmallow 210 may be removed from auxiliary food carrier 220 with spatula 215 as shown and described in conjunction with FIGS. 33 and 34.

As explained above, to toast marshmallows 210 with toasting machine 50, knob 190 is set to a preselected toasting time, such as one minute, two minutes, three minutes, or other selected time, whereby activation of switch 194 from its OFF position to its ON position closes the toasting circuit for the preselected toasting period of time, at the close of which the toasting circuit opens. If desired, timer 184 can be set to a preselected toasting time via knob 190 after switch 184 is activated in its ON position. In this embodiment, after switch 184 is switched ON, namely, activated, the toasting circuit remains open. However, when knob 190 is set to a preselected toasting time, the toasting circuit closes and remains closed for the preselected toasting time, at the close of which the toasting circuit is opened. This process may be repeated for subsequent toasting.

Switch 184 is formed in floor 86 to as to be activated by food carrier 200 when positioned in its toasting position in toasting chamber 101. Switch 184 can be located at other positions in alternate embodiments so as to be activated by food carrier 200 when positioned in its toasting position in toasting chamber.

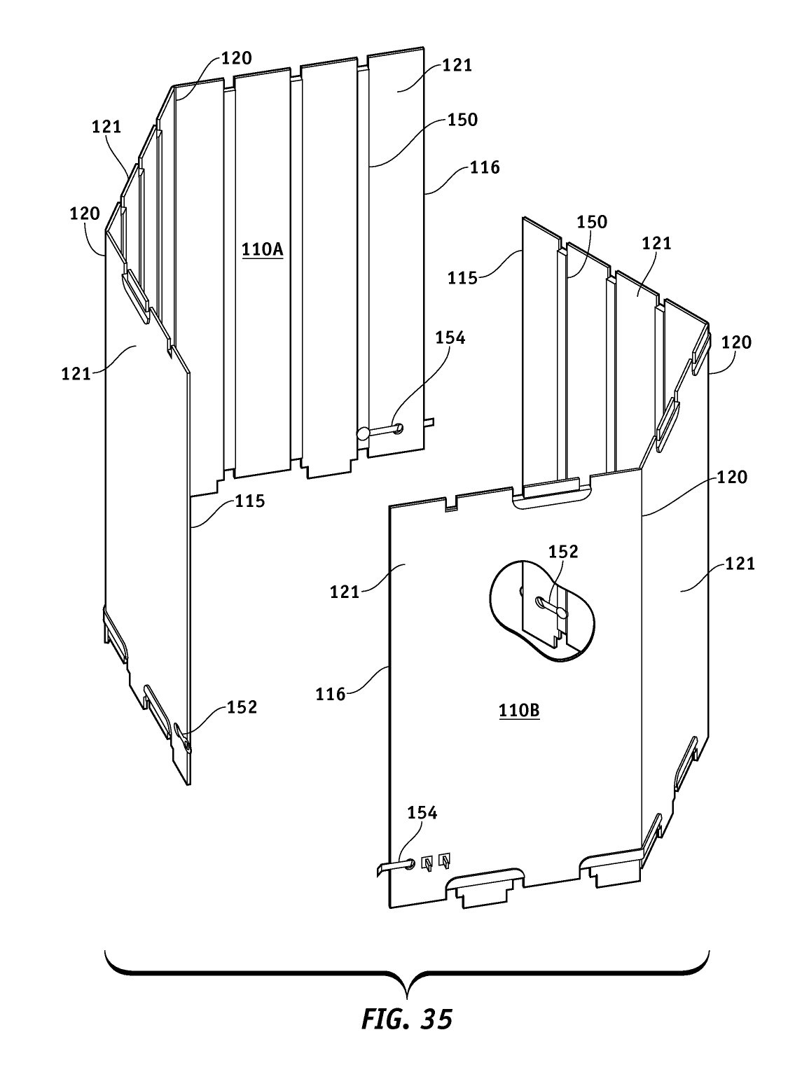

Heating source 100 is formed by wall 110, resistance wire 150 carried by wall 110, and contacts 152 and 154 formed in side extremities 115 and 116 for that when connected convert resistance wire 150 into a continuous loop in preparation for being energized to generate heat. FIG. 35 shows an alternate embodiment of a heating source 230 that is made of two identical and separate walls 110A and 110A. Walls 110A and 110B each include resistance wire 150 and contacts 152 and 154 at the respective side extremities 115 and 116. In this embodiment, walls 110A and 110B each include two hinges 120 that join three wall segments 121. As in heating source 100, each wall segment 121 is joined to an adjacent wall segment 121 via a hinge 120 to enable the folding of each wall segment 121 relative to an adjacent wall segment 121, and further to enable walls 110A and 110B to each be folded inwardly as shown in FIG. 35. Walls 110A may then be combined to bring side extremities 115 and 116 of the opposed walls 110A and 110B together so as to be in contact with one another to configure wall into the ring or annulus, as in FIGS. 7 and 11, at which point contacts 152 and 154 between the opposed pairs of side extremities 115 and 116 may be connected to convert resistance wire 150 into a continuous loop. Other than this, the resulting heating source 230 is identical in every respect to heating source 100.

With momentary reference back to FIG. 18, housing 51 as an overall height from bottom 66 to top 70 of approximately 5½ inches, and an overall outer diameter of approximately 5½ inches. Access into toasting chamber 101 is provided via collar 80. Collar 80 has a height of approximately 1¾ inches from inner edge 75 of top 70 to distal edge 83, and wall 110 of heating source 100 has an overall height from lower upper extremity 113 to lower extremity of approximately 3¼ inches. Opening 76 and subjacent opening 84 each have a diameter of approximately 2¾ inches, and inner surface 82 likewise defines an inner diameter of collar of 2¾ inches that extends from opening 76 to subjacent opening 84. The minimum inner diameter of toasting chamber 101 defined between the inner surfaces 123 of opposed wall segments 121 is approximately 2 13/16 inches. These dimensions are illustrated as a matter of example and other dimensions can be used consistent with this disclosure without departing from the invention. The height of collar 80 into toasting chamber 101 is a protective feature and is chosen to make it difficult for an individual, such as a child, to stick his/her finger into toasting chamber 101 through collar 80 to become burned during the operation of toasting machine 50.

Those having regard for the art will readily appreciate that an exemplary toasting machine 50 is disclosed, which is easy to manufacture, has no moving parts, and is particularly structured for uniformly/evenly toasting marshmallows without the need for rotating the marshmallows relative to a heating source. While toasting machine is particularly suitable for toasting marshmallows, it may be used to toast other food products, such as rolls, pastries, meatballs, etc.

The invention has been described above with reference to preferred embodiments. Those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A toasting machine for toasting a food product, the toasting machine comprising:
a housing, the housing includes a bottom and a top;
a heating source for toasting a food product, the heating source is mounted in the housing and extends upright in a direction from the bottom of the housing to the top of the housing, and completely encircles a toasting chamber in the housing for sourcing surrounding heat to the toasting chamber; and
an opening in the top of the housing that communicates with the toasting chamber for admitting a food product into the toasting chamber for toasting.

2. The toasting machine according to claim 1, wherein the heating source comprises:
a wall of heat-insulative material, the wall extends upright and has an inner face that completely encircles the toasting chamber; and
resistance wire carried by the wall, the resistance wire being uniformly distributed along the inner face of the wall for sourcing surrounding heat to the toasting chamber.

3. The toasting machine according to claim 2, further comprising the resistance wire arranged in spaced-apart parallel rows that extend upright along the inner face of the wall in concert with the wall.

4. The toasting machine according to claim 2, wherein the wall comprises a plurality of wall segments.

5. The toasting machine according to claim 4, wherein each wall segment is joined to an adjacent wall segment via a hinge.

6. The toasting machine according to claim 5, wherein the hinge joining each wall segment to an adjacent wall segment is a living hinge.

7. The toasting machine according to claim 1, further comprising a timer for automatically timing the heating source operating to automatically apply surrounding heat to the toasting chamber for select time periods.

8. A toasting machine for toasting a food product, the toasting machine comprising:
a housing, the housing includes a bottom and a top;
a floor of heat-resistant material, the floor is in the housing near the bottom and opposes the top;
a heating source for toasting a food product, the heating source is in the housing between the floor and the opening, extends upright in a direction from the floor near the bottom of the housing to the top of the housing, completely encircles a toasting chamber in the housing for sourcing surrounding heat to the toasting chamber, and is coupled between the floor and the housing; and
an opening in the top of the housing that communicates with the toasting chamber for admitting a food product into the toasting chamber for toasting.

9. The toasting machine according to claim 8, wherein the heating source comprises:
a wall of heat-insulative material, the wall has a lower extremity, an upper extremity, and an inner face, the wall extends upright from the lower extremity connected to the floor to the upper extremity connected to the housing, and the inner face completely encircles the toasting chamber; and
resistance wire carried by the wall, the resistance wire being uniformly distributed along the inner face of the wall for sourcing surrounding heat to the toasting chamber.

10. The toasting machine according to claim 9, further comprising the resistance wire arranged in spaced-apart parallel rows that extend upright along the inner face of the wall in concert with the wall.

11. The toasting machine according to claim 9, wherein the wall comprises a plurality of wall segments.

12. The toasting machine according to claim 11, wherein each wall segment is joined to an adjacent wall segment via a hinge.

13. The toasting machine according to claim 12, wherein the hinge joining each wall segment to an adjacent wall segment is a living hinge.

14. The toasting machine according to claim 8, further comprising a timer for automatically timing the heating source operating to automatically apply surrounding heat to the toasting chamber for select time periods.

15. The toasting machine according to claim 8, further comprising guides formed in the top of the housing for receiving and guiding a food carrier into the toasting chamber through the opening.

16. A toasting machine for toasting a food product, the toasting machine comprises:
a housing, the housing includes a bottom and a top;
a floor of heat-resistant material, the floor is in the housing near the bottom and opposes the top;
a heating source for toasting a food product, the heating source is in the housing between the floor and the opening, extends upright in a direction from the floor near the bottom of the housing to the top of the housing, completely encircles a toasting chamber in the housing for sourcing surrounding heat to the toasting chamber, and is coupled between the floor and the housing;
an opening in the top of the housing that communicates with the toasting chamber for admitting a food carrier into the toasting chamber in a toasting position for positioning a food product held by the food carrier in the toasting chamber;
timer for automatically timing the heating source operating to automatically apply surrounding heat to the toasting chamber for select time periods; and
a switch in the housing operatively coupled to the timer, the switch activatable by the food carrier for activating the timer and the heating source in response to positioning the food carrier in the toasting position in the toasting chamber.

17. The toasting machine according to claim 16, wherein the heating source comprises:
a wall of heat-insulative material, the wall has a lower extremity, an upper extremity, and an inner face, the wall extends upright from the lower extremity connected to the floor to the upper extremity connected to the housing, and the inner face completely encircles the toasting chamber; and
resistance wire carried by the wall, the resistance wire being uniformly distributed along the inner face of the wall for sourcing surrounding heat to the toasting chamber.

18. The toasting machine according to claim 16, further comprising the resistance wire arranged in spaced-apart parallel rows that extend upright along the inner face of the wall in concert with the wall.

19. The toasting machine according to claim 16, wherein the wall comprises a plurality of wall segments.

20. The toasting machine according to claim 19, wherein each wall segment is joined to an adjacent wall segment via a hinge comprising a living hinge.
